(19) United States
(12) Patent Application Publication
(10) Pub. No.: US 2010/0162568 A1
(43) Pub. Date: Jul. 1, 2010

(54) OUTER BLADE FOR RECIPROCATION-TYPE ELECTRIC SHAVER AND METHOD OF PRODUCING THE SAME

(75) Inventor: Tatsuji Kawaguchi, Suita (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/377,071

(22) PCT Filed: Oct. 2, 2007
(86) PCT No.: PCT/JP2007/069254

§ 371 Date: Feb. 10, 2009

(30) Foreign Application Priority Data
Oct. 13, 2006 (JP) 2006-280531

(51) Int. Cl. B26B 19/02; B21K 11/00

(52) U.S. Cl. 30/43.92; 76/104.1

(57) ABSTRACT

Provided are an outer blade for a reciprocation-type electric shaver and a method of producing the outer blade, the outer blade being capable of suppressing a deformation such as wrinkles or an undulation, without adding a new component, to thereby keep a good appearance thereof. A sheet material for forming the outer blade is bent into a shape projecting upward when viewed in the lateral directions. The sheet material has hair introduction holes, the peripheral edge of each hair introduction hole forming a projection section projecting inward beyond the other portion of the sheet material, the end surfaces of a part of the projection sections make contact with a reciprocating inner blade. The sheet material is formed with a deformation suppression section in a specific region not including the projection sections which make contact with the inner blade but including the projection sections which make no contact with the inner blade. The deformation suppression section extends in a direction, the projection sections included in the deformation suppression section being crushed by pressing from the inside of the sheet material.

### TECHNICAL FIELD

The present invention relates to an outer blade for a reciprocation-type electric shaver and a method of producing the outer blade.

### BACKGROUND ART

There is conventionally known a reciprocation-type electric shaver which includes an outer blade and an inner blade adapted to laterally reciprocate while sriding on the inner surface of the outer blade. Patent Document 1 shows an outer blade formed of a quadrangular sheet material having a large number of hair introduction holes and bent into a shape projecting upward when viewed in the lateral directions (e.g., reverse-U shape). In the sheet material, the peripheral edge of each hair introduction hole forms a projection section embossed inward (i.e., projecting inward beyond the other portion), and an inner blade reciprocates in contact with the end surface of each projection section to thereby cut a hair inserted through the corresponding hair introduction hole.

The outer blade formed of the quadrangular sheet material bent in the shape projecting upward in lateral view has a side portion forming a side surface, and the side portion has such a low rigidity that a deformation such as wrinkles or an undulation tends to be produced in lower-end portions of the side faces. Particularly, an outer blade formed by, in addition to the above bending, bending in a different direction so as to curve the upper edge thereof in an arc when viewed from the front, allows a surplus of the material to be produced on the lower-edge side, which further promote the deformation. The above deformations deteriorate an appearance of the outer blade.

For suppression of the deformations, Patent Document 1 described above and Patent Document 2 show a deformation prevention plate attached to a lower end of the easily-deformed side faces of the sheet material, separately therefrom. However, the addition of the deformation prevention plate increases material expense of the outer-blade and the number of man-hour for assembly, thereby increasing cost.

### Patent Document 1: Japanese Patent Laid-Open Publication No. 63-286180

### Patent Document 2: Japanese Patent Publication No. 8-8949

### DISCLOSURE OF THE INVENTION

It is an object of the present invention to provide an outer blade for a reciprocation-type electric shaver capable of suppressing a deformation such as wrinkles and an undulation in the outer blade, without adding a component such as the deformation prevention plate, to thereby keep a good appearance, and a method of producing the outer blade.

An outer blade for a reciprocation-type electric shaver according to the present invention is formed of a sheet material bent into a shape projecting upward when viewed in the lateral directions. The sheet material has hair introduction holes through the sheet material in the thickness directions thereof, the peripheral edge of each of the hair introduction holes forms a projection section projecting inward beyond the other portion of the sheet material. The end surfaces of a part of the projection sections make contact with an inner blade of the reciprocation-type electric shaver reciprocating to cut a hair inserted through the corresponding hair introduction holes. Furthermore, the sheet material is formed with a deformation suppression section in a specific region not including the projection sections which make contact with the inner blade but including the projection sections which make no contact with the inner blade. The deformation suppression section extends in a direction, and the projection sections included in the deformation suppression section are crushed by pressing the projection sections from the inside of the sheet material.

A method of producing an outer blade for a reciprocation-type electric shaver according to the present invention includes: a process of producing a sheet material forming the outer blade, the sheet material having hair introduction holes through the sheet material in the thickness directions thereof, and the peripheral edge of each hair introduction hole forming a projection section projecting inward beyond the other portion of the sheet material; a process of bending the sheet material into a shape projecting upward when viewed in the lateral directions; and a process of forming a deformation suppression section suppressing a deformation of the lower end of the sheet material, in a specific region of the sheet material not including the projection sections which make contact with the inner blade of the reciprocation-type electric shaver but including the projection sections which make no contact with the inner blade. In the process of forming a deformation suppression section, the projection sections included in the region of the deformation suppression section are crushed by pressing the deformation suppression section from the inside of the sheet material.

Herein, “the projection sections are crushed” is not limited to a complete crush of the projection sections, but includes such a crush as to leave a part of the inward projection of each projection section (e.g., such a crush as to incline each projection section by a predetermined angle radially inwardly).

In the above outer blade and method of producing the outer blade, the crush of the projection sections included in the deformation suppression section by pressing them from the inside rigidifies lower-end portions of the outer blade to suppress a deformation such as wrinkles and an undulation in the lower-end portions. Besides, the formation of the deformation suppression section has little effect on the shape of the outer surface of the outer blade, which permits an improvement of the appearance of the outer blade. Furthermore, the suppression of the deformation requires no addition of any separate component, thus involving no cost increase due to the addition.

### BRIEF DESCRIPTION OF THE DRAWINGS

FIG. 1A is a perspective view of an outer blade formed of a sheet material bent only in first directions according to an embodiment of the present invention and FIG. 1B is a perspective view of an outer blade formed of the sheet material bent in the first directions and in second directions according to the embodiment.

FIG. 2 is a front view of the outer blade shown in FIG. 1B.

FIG. 3 is a sectional side view of the outer blade shown in FIG. 1B.

FIG. 4 is a perspective view of a not-yet bent sheet material for forming the outer blade.

FIG. 5 is an enlarged perspective view showing a main part of the sheet material of FIG. 4.

FIG. 6 is a sectional view taken on VI-VI line of FIG. 5.

FIG. 7 is a schematic perspective view showing a deformation suppression section formed in the sheet material forming the outer blades shown in FIGS. 1A and 1B.

FIG. 8 is a sectional view taken on VIII-VIII line of FIG. 7.

FIG. 9 is a sectional view taken on IX-IX line of FIG. 7.

FIG. 10 is a perspective view showing a punch and a die for bending the sheet material.

FIG. 11A is a perspective view showing a main part of an outer blade formed with a deformation suppression section extending laterally and FIG. 11B is a perspective view of the punch for shaping the outer blade of FIG. 11A, which punch has lateral ribs for forming the deformation suppression section.

FIG. 12A is a perspective view showing a main part of an outer blade formed with a deformation suppression section extending laterally and FIG. 12B is a perspective view of the punch for shaping the outer blade of FIG. 12A, which punch has vertical ribs for forming the deformation suppression section.

### BEST MODE FOR IMPLEMENTING THE INVENTION

The best mode for implementing the present invention will be below described in detail with reference to the drawings.

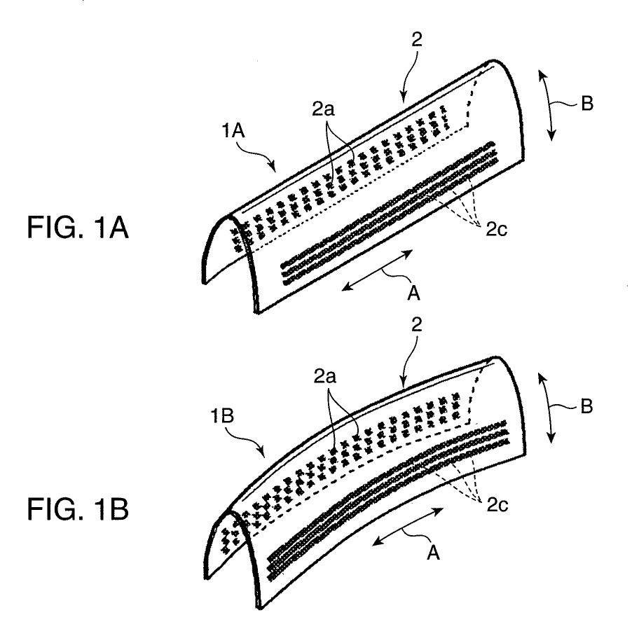

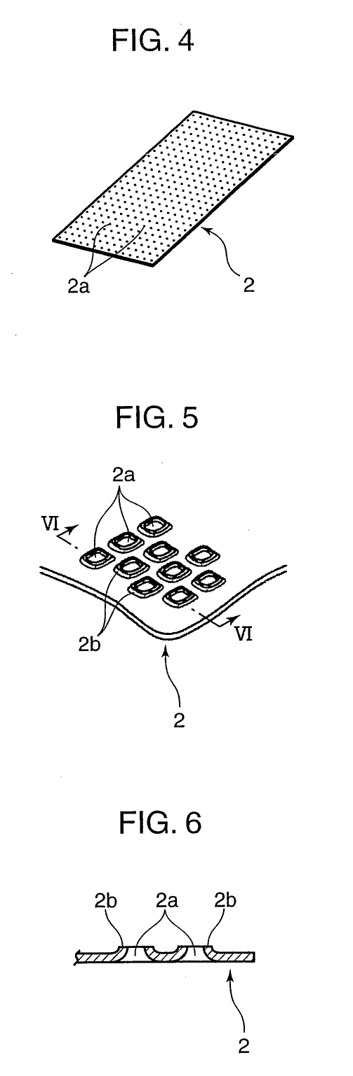

FIGS. 1A and 1B show outer blades 1A and 1B, respectively, for a reciprocation-type electric shaver according to an embodiment of the present invention. Either of the outer blades 1A and 1B are each formed of a quadrangular sheet material 2 having many hair introduction holes 2a arranged vertically and laterally. The peripheral edge of each hair introduction hole 2a forms, as shown in FIGS. 4 to 6, a projection section 2b embossed inward (upward in FIGS. 4 and 5), in other words, projecting inward beyond the other portion.

The outer blade 1A of FIG. 1A is formed by bending the sheet material 2 originally shaped like a flat plate shown in FIG. 4 into a reverse-U shape, specifically, in such away that the middle thereof projects upward when viewed in a lateral direction (i.e., in a first direction). On the other hand, the outer blade 1B of FIG. 1B is formed by further bending the sheet material 2 bent in the first direction in such a way that the upper edge thereof is curved in an arc when viewed from the front (i.e., in second directions different from the first directions).

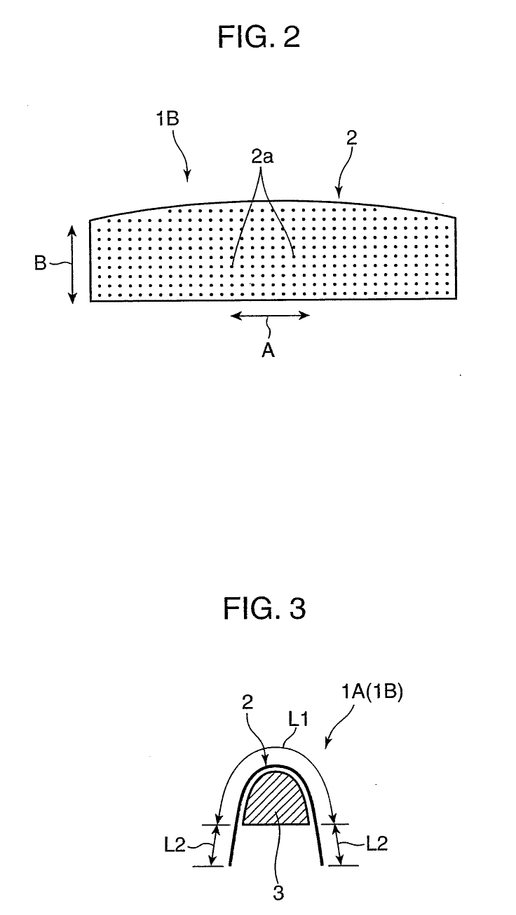

Each outer blade 1A, 1B constitutes a reciprocation-type electric shaver in combination with an inner blade 3 shown in FIG. 3. The inner blade 3 reciprocates laterally (in the directions shown by an arrow A of FIG. 2) in contact with the end surfaces of projection sections 2b within a specific region L1 among the projection sections 2b of the outer blade 1 while a hair is inserted through each hair introduction hole 2a, to thereby cut the hair in collaboration with the end surfaces (as practical outer blades) of the corresponding projection sections 2b.

As shown in FIG. 3, the region L1 is a region including a vertex portion of the sheet material 2 except regions L2 near both lower-end portions thereof. In other words, each of the regions L2 near both lower-end portions is a region not including the projection sections 2b which make into contact with the inner blade 3 but including the projection sections 2b which make no contact with the inner blade 3.

The quadrangular sheet material 2 forming each outer blade 1A, 1B is generally made of a stainless material subjected to quenching. Their dimensions may be suitably set. In general, it is preferable that the thickness is approximately 0.035 mm, and is approximately 0.063 mm when including the embossed sections 2b of the hair introduction holes 2a. The suitable diameter of each hair introduction hole 2a is approximately 0.4 mm and the suitable hole pitch is approximately 0.5 mm.

Also the shape of each hair introduction hole 2a may also be suitably set. In general, the hair introduction holes 2a formed in the region L1 where the inner surface of the sheet material 2 (i.e., the end surfaces of the projection sections 2b) makes contact with the inner blade 3 have a hexagonal shape, while the hair introduction holes 2a formed in the region L2 where the inner surface makes no contact with the inner blade 3 have a quadrangular shape.

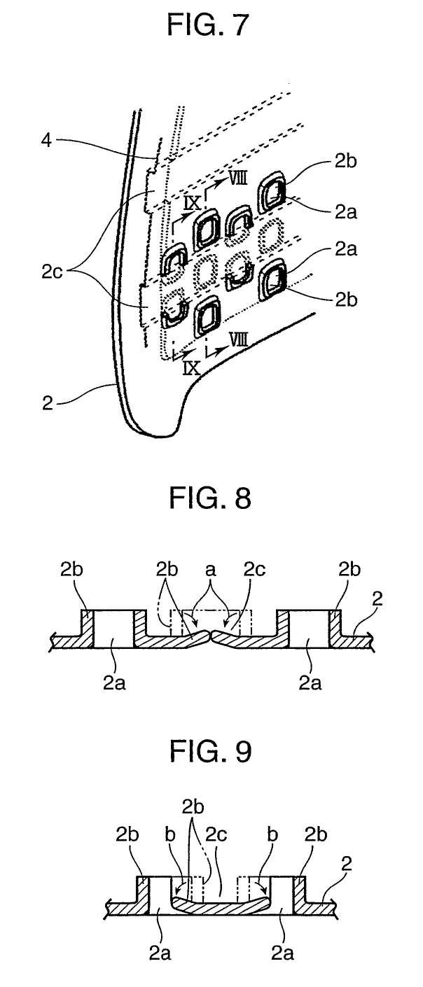

The hair introduction holes 2a are arranged at a specified pitch in the longitudinal directions of the outer blade 1, i.e., lateral directions (the directions shown by the arrow A of FIG. 2) while shifted by half the pitch from each other in the vertical directions of the outer blade 1, i.e., short-side directions (the directions shown by an arrow B of FIG. 2), as shown in FIG. 7. In other words, the hair introduction holes 2a are arranged in zigzag form in the directions shown by the arrow A (in the lateral directions).

Either of the outer blades 1A and 1B tends to have a deformation at the lower-end portions of the sheet material 2 forming the outer blade 1. Specifically, since the outer blade 1A is formed by bending the sheet material 2 originally shaped like a flat plate into a reverse-U shape (curved line projecting upward) in lateral view (i.e., in the first directions) and the outer blade 1B is formed by bending the sheet material 2 originally shaped like a flat plate into a reverse-U shape (curved line projecting upward) and into a shape curved in an arc in front view (i.e., in the first directions and in the second directions different from the first directions), each bending produces surpluses of the material in both lower-end portions respectively, which is likely to produce a deformation such as wrinkles or an undulation.

In order to suppress the deformation, either of the outer blades 1A and 1B is formed with a deformation suppression section 2c in a specific region within the regions L2 of the sheet material 2, specifically, in each of a plurality of specific regions not including the projection sections 2b which make contact with the inner blade 3 but including the projection sections 2b which make no contact with the inner blade 3. Each deformation suppression section 2c is a section where the projection sections 2b are crushed by pressing from the inside of the sheet material 2.

The shapes and the number of the deformation suppression sections 2c and the degree to which the projection sections 2b included in the deformation suppression sections 2c are crushed may be suitably set. In the example shown in FIGS. 7 to 9 and 11, the projection sections included in the deformation suppression sections 2c are crushed by a length less than the original projection height thereof in such a way that each projection section 2b inclines by a predetermined angle radially inwardly, leaving a part of the inward projection of each projection section 2b.

In the example of FIGS. 7 to 9 and 11, a plurality of deformation suppression sections 2c extending in the lateral directions (shown by the arrow A) are formed in a plurality of positions aligned vertically, respectively, each having a width (a vertical dimension) substantially equal to the vertical dimension of a single projection section 2b. Since the hair introduction holes 2a and the projection sections 2b corresponding to the peripheral edge thereof according to this embodiment are arranged in zigzag form as described above, the deformation suppression sections 2c include the projection sections 2b crushed over the whole thereof shown by an arrow a of FIG. 8 and the projection sections 2b crushed partly only in the upper or lower part thereof shown by an arrow b of FIG. 9.

In this example, the suitable width (vertical dimension) of each deformation suppression section 2c is approximately 0.4 mm and the suitable distance in the vertical directions (shown by the arrow B) between each deformation suppression section 2c is approximately 0.8 mm. The number of the deformation suppression sections 2c, which is three in the figures, may be two or below, or four or above.

As another example, FIG. 12 shows a sheet material 2, which is formed with a plurality of deformation suppression sections 2c extending vertically in a plurality of rows arranged in the lateral directions (shown by the arrow A), respectively. Also in this case, the suitable width (lateral dimension) of each deformation suppression section 2c is approximately 0.4 mm and the suitable lateral distance between each deformation suppression section 2c is approximately 0.8 mm. The sheet material 2 shown in FIG. 12 is formed with thirteen deformation suppression sections 2c, but the number of the deformation suppression sections 2c may be twelve or below, or fourteen or above.

In addition, the extending direction of deformation suppression sections are not limited to the lateral or vertical directions, but may be oblique directions.

In FIGS. 7, 11 and 12, a solid line 4, though indicating channels, is merely drawn for convenience of showing where the deformation suppression sections 2c is formed, not meaning that the channels should be actually formed in the inner surface of the sheet material 2.

In either outer blade, the crush of some or all of the projection sections 2b included in the deformation suppression sections 2c of the sheet material 2, which make no contact with the inner blade 3, by pressing them from the inside, causes a residual stress. The residual stress braces lower-end portions of the sheet material 2 forming the outer blade 1A (1B) to rigidify them, thereby suppressing a deformation such as wrinkles or an undulation in the lower-end portions. Besides, the pressing for forming the deformation suppression sections 2c does not affect the shape of the outer surfaces of the outer blade 1A (1B) (in FIGS. 1A and 1B, the shape of each deformation suppression section 2c is shown by a broken line, but the shape cannot be seen from the outside of the outer blade 1A (1B)), which improves the appearance of the outer blade 1A (1B). Furthermore, there is no need to add a deformation prevention plate as a separate component provided like a conventional outer blade, which involves no increase in cost.

Next will be described a method of producing the outer blade 1A and the outer blade 1B.

First is formed a sheet material 2 having a flat-plate shape shown in FIGS. 4 to 6. The sheet material 2 is provided with numerous hair introduction holes 2a, each peripheral edge of which forms a projection section 2b projecting inward.

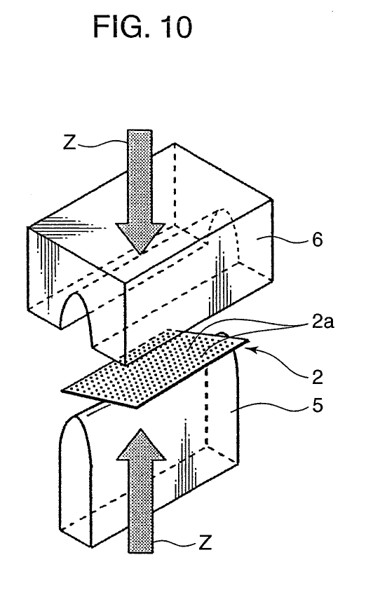

Next, the sheet material 2 is bent into a shape projecting upward, using a punch 5 and a die 6 for pressing shown in FIG. 10, for example. The punch 5 has an outer surface shape corresponding to the inner-surface shape of the outer blade 1 and the die 6 has an inner surface shape corresponding to the outer surface shape of the outer blade 1. The sheet material 2 is placed between the punch 5 and the die 6, as shown by arrows Z of FIG. 10, to be pressed from above and below, thereby formed into a target outer-blade shape.

If the ridge part of the punch 5 and the valley part of the die 6 are both straight in front view, formed is an outer blade 1A of the type shown in FIG. 1A, which is formed of the sheet material 2 bent only in the first directions. On the other hand, if the punch 5 and the die 6 have a ridge part and a valley part, respectively, curved in an arc in front view, formed is an outer blade 1B of the type having an upper edge curved in an arc in front view shown in FIG. 1B, which is formed of the sheet material 2 bent in both the first and second directions. Differently from this, the method of producing the latter outer blade 1B may include pressing for bending the sheet material 2 in the first directions and pressing for bending the sheet material 2 in the second directions separately.

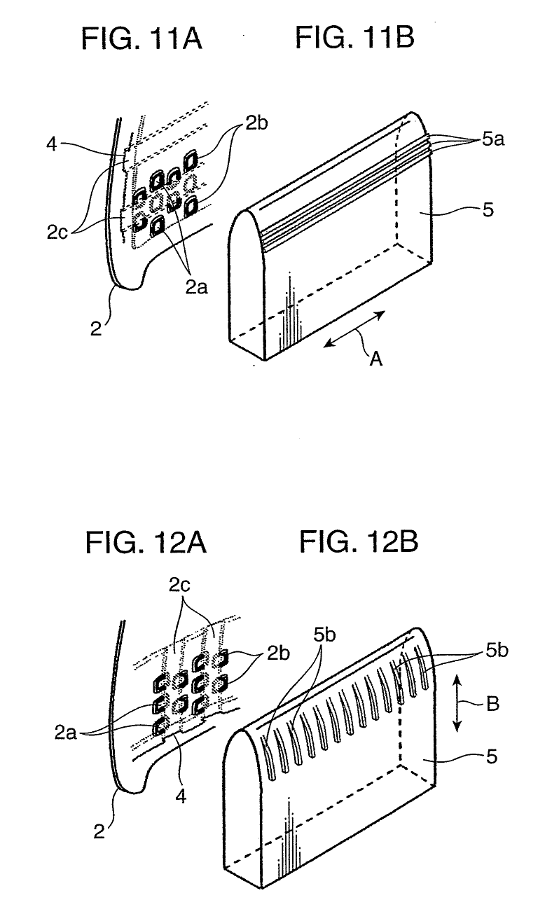

In the above bending (pressing), using a punch having an outer surface given respective ribs corresponding to the deformation suppression sections 2c as the punch 5 enables the punch 5 to also serve as a jig for forming a deformation suppression section, which allows the deformation suppression sections 2c to be formed simultaneously with the bending also functions. For example, in order to form the sheet material 2 into a shape having deformation suppression sections 2c extending in the lateral directions shown by the arrow A in FIG. 11A, the outer surface of the punch 5 may be given a plurality of ribs 5a each of which extends laterally corresponding to each deformation suppression section 2c as shown in FIG. 11B. Likewise, in order to form the sheet material 2 into a shape having deformation suppression sections 2c extending in the vertical directions shown by the arrow B in FIG. 12A, the outer surface of the punch 5 may be formed with a plurality of ribs 5b each of which extends in the vertical directions B corresponding to each deformation suppression section 2c as shown in FIG. 12B.

Using the punch 5 of FIG. 11B or FIG. 12B make it possible to form the deformation suppression sections 2c (e.g., to crush the projection sections 2b included in the deformation suppression sections 2c) simultaneously with bending the sheet material 2, thereby improving production efficiency of the outer blade. However, the deformation suppression sections 2c also may be formed in isolation by a punch and a die for exclusive use after the bending of the sheet material 2 (bending in the first directions or in the first and second directions).

As described so far, the present invention provides an outer blade for a reciprocation-type electric shaver and a method of producing the outer blade. The outer blade is formed of a sheet material bent into a shape projecting upward when viewed in the lateral directions. The sheet material has hair introduction holes through the sheet material in the thickness directions thereof, the peripheral edge of each hair introduction hole forms a projection section projecting inward beyond the other portion of the sheet material, and a part of the projection sections make contact with an inner blade of the reciprocation-type electric shaver reciprocating to cut a hair inserted through the corresponding hair introduction hole.

In addition, the sheet material is formed with a deformation suppression section in a specific region not including the projection sections which make contact with the inner blade but including the projection sections which make no contact with the inner blade. The deformation suppression section extends in a direction, and the projection sections included in the deformation suppression section are crushed by pressing from the inside of the sheet material. This causes a residual stress in the sheet material to rigidify lower-end portions of the sheet material, suppressing a deformation such as wrinkles or an undulation in the lower-end portions. Besides, the formation of the deformation suppression sections has little effect on the shape of the outer surface of the outer blade, which permits an improvement of the appearance of the outer blade. Furthermore, the suppressing of the deformation requires no addition of a separate component, not involving an increase in cost due to the addition of the component.

The projection sections may be so crushed as to leave a part of the inward projection thereof. For example, the projection sections may be so crushed as to incline radially inwardly by a predetermined angle.

In case that the end surfaces of the projection sections within a region including a vertex portion of the sheet material in the outer blade makes contact with the inner blade, the deformation suppression section may be formed within a region other than the above region and near both lower-end portions of the sheet material. This effectively suppresses deformations especially in both lower-end portions.

In the present invention, more desirably, a plurality of deformation suppression sections may be spaced perpendicularly to directions in which the deformation suppression sections extend, thereby further enhancing the effect on deformation suppression. Specifically, it is preferable that the deformation suppression sections extend laterally of the outer blade and are spaced vertically of the outer blade, or that the deformation suppression sections extend vertically of the outer blade and are spaced laterally of the outer blade.

The present invention can be effectively applied also to the outer blade in which the sheet material has an upper-edge portion curved in an arc when viewed from the front thereof.

In the method of producing an outer blade according to the present invention, it is preferable that the process of forming a deformation suppression section, for example, includes pressing the inner surface of the sheet material against a jig having an outer surface formed with a rib in a shape corresponding to the shape of the deformation suppression section to thereby let the rib press a specific projection section of the sheet material from the inside to crush it. This method permits an efficient formation of the deformation suppression section.

Furthermore, in the process of bending the sheet material into a shape projecting upward when viewed laterally, the bending may be conducted through pressing using a punch having an outer surface in a shape corresponding to the shape of the inner surface of the outer blade and a die having an inner surface in a shape corresponding to the shape of the outer surface of the outer blade, the rib being formed on the outer surface of the punch. This enables the sheet material to be formed with the deformation suppression section simultaneously with the pressing, by using the rib, thereby establishing more efficient production of the outer blade.

In this case, the punch may be preferably formed with a plurality of ribs on its outer surface, the ribs spaced perpendicularly to directions in which the ribs extend. Specifically, the punch having an outer surface on which a plurality of ribs extending laterally are spaced vertically or a plurality of ribs extending vertically are spaced laterally is suitable.

The present invention is especially effective in case of bending the sheet material into a shape having an upper-edge portion thereof curved in an arc when viewed from the front. Since this bending may increase a surplus of the material in lower-end portions of the sheet material to promote the deformation further, forming the deformation suppression section in the sheet material is effective.

1. An outer blade for a reciprocation-type electric shaver which includes the outer blade and an inner blade reciprocating inside of the outer blade, wherein:
the outer blade is formed of a sheet material bent into a shape projecting upward when viewed in the lateral directions;
the sheet material has hair introduction holes through the sheet material in the thickness directions thereof, the peripheral edge of each hair introduction hole forming a projection section projecting inward beyond the other portion of the sheet material, a part of the projection sections each having a shape in which the end surface of the projection section makes contact with the inner blade of the reciprocation-type electric shaver reciprocating to cut a hair inserted through the corresponding hair introduction hole; and
the sheet material is formed with a deformation suppression section extending in a direction in a specific region not including the projection sections which make contact with the inner blade but including the projection sections which make no contact with the inner blade, and the projection sections included in the deformation suppression section are crushed by pressing from the inside of the sheet material.

2. The outer blade for a reciprocation-type electric shaver according to claim 1, wherein the projection sections included in the deformation suppression section are so crushed as to leave a part of the inward projection of each projection section.

3. The outer blade for a reciprocation-type electric shaver according to claim 2, wherein the projection sections included in the deformation suppression section are so crushed as to incline radially inwardly thereof by a predetermined angle.

4. The outer blade for a reciprocation-type electric shaver according to claim 1, wherein the end surfaces of the projection sections within a region including a vertex portion of the sheet material in the outer blade makes contact with the inner blade, while the deformation suppression section is formed within a region other than the region including the vertex portion and near both lower-end portions of the sheet material.

5. The outer blade for a reciprocation-type electric shaver according to claim 1, wherein a plurality of deformation suppression sections are spaced perpendicularly to directions in which the deformation suppression sections extend.

6. The outer blade for a reciprocation-type electric shaver according to claim 5, wherein the deformation suppression sections extend laterally of the outer blade, spaced vertically of the outer blade.

7. The outer blade for a reciprocation-type electric shaver according to claim 5, wherein the deformation suppression sections extend vertically of the outer blade and are spaced laterally of the outer blade.

8. The outer blade for a reciprocation-type electric shaver according to claim 1, wherein the sheet material has an upper-edge portion curved in an arc when viewed from the front thereof.

9. A method of producing an outer blade for a reciprocation-type electric shaver which includes the outer blade and an inner blade reciprocating inside of the outer blade, comprising:
a process of producing a sheet material for forming the outer blade, the sheet material having hair introduction holes through the sheet material in the thickness directions thereof, the peripheral edge of each hair introduction hole forming a projection section projecting inward beyond the other portion of the sheet material;
a process of bending the sheet material into a shape projecting upward when viewed in the lateral directions; and
a process of forming a deformation suppression section for suppressing a deformation of the lower end of the sheet material, the deformation suppression section being formed in a specific region of the sheet material not including the projection sections which make contact with the inner blade of the reciprocation-type electric shaver but including the projection sections which make no contact with the inner blade,
wherein, in the process of forming a deformation suppression section, the projection sections included in the deformation suppression section are crushed by pressing from the inside of the sheet material.

10. The method of producing an outer blade for a reciprocation-type electric shaver according to claim 9, wherein, in the process of forming a deformation suppression section, the projection sections included in the deformation suppression section are so partially crushed as to leave a part of the inward projection of each projection section.

11. The method of producing an outer blade for a reciprocation-type electric shaver according to claim 10, wherein the projection sections included in the deformation suppression section are so crushed as to incline radially inwardly thereof by a predetermined angle.

12. The method of producing an outer blade for a reciprocation-type electric shaver according to claim 10, wherein, in the process of forming a deformation suppression section, the inner surface of the sheet material is pressed against a jig having an outer surface formed with a rib in a shape corresponding to the shape of the deformation suppression section to thereby let the job press a specific projection section of the sheet material from the inside to crush it.

13. The method of producing an outer blade for a reciprocation-type electric shaver according to claim 12, wherein, in the process of bending the sheet material into a shape projecting upward when viewed in the lateral directions, the bending is conducted through pressing using a punch having an outer surface in a shape corresponding to the shape of the inner surface of the outer blade and a die having an inner surface in a shape corresponding to the shape of the outer surface of the outer blade, the rib being formed on the outer surface of the punch to form the deformation suppression section in the sheet material simultaneously with the pressing.

14. The method of producing an outer blade for a reciprocation-type electric shaver according to claim 13, wherein the punch is formed with a plurality of rims on the outer surface thereof, the ribs spaced perpendicularly to directions in which the ribs extend.

15. The method of producing an outer blade for a reciprocation-type electric shaver according to claim 14, wherein the ribs extend laterally and are spaced vertically on the outer surface of the punch.

16. The method of producing an outer blade for a reciprocation-type electric shaver according to claim 14, wherein the ribs extend laterally and are spaced vertically on the outer surface of the punch.

17. The method of producing an outer blade for a reciprocation-type electric shaver according to claim 9, wherein the sheet material is bent into a shape having an upper-edge portion curved in an arc when viewed from the front.
